(19) United States
(12) Patent Application Publication
(10) Pub. No.: US 2025/0098681 A1
(43) Pub. Date: Mar. 27, 2025

(54) HIGH CONCENTRATION LOW VOLATILITY SOLUTION OF PLANT GROWTH REGULATOR

(71) Applicant: RITESH B. SHETH, HOLLY SPRINGS, NC (US)

(72) Inventor: RITESH B. SHETH, HOLLY SPRINGS, NC (US)

(21) Appl. No.: 18/886,613

(22) Filed: Sep. 16, 2024

Related U.S. Application Data
(60) Provisional application No. 63/585,711, filed on Sep. 27, 2023.

(51) Int. Cl. A01N 43/90; A01N 25/02; A01N 43/12; A01N 43/38; A01P 13/00

(52) U.S. Cl. CPC A01N 43/90; A01N 25/02; A01N 43/12; A01N 43/38; A01P 13/00

(57) ABSTRACT

The present disclosure generally relates to high concentration Plant Growth Regulators (PGRs) in non-aqueous, low volatility solutions, methods for making said non-aqueous low volatility solutions, and methods for improving the growth and crop productivity of plants using said non-aqueous solution.

This non-provisional patent application claims all benefits under 35 U.S.C. § 119(e) of pending U.S. provisional patent application Ser. No. 63/585,711 filed 27 Sep. 2023, entitled “HIGH CONCENTRATION LOW VOLATILITY SOLUTION OF PLANT GROWTH REGULATOR”, in the United States Patent and Trademark Office, which is incorporated by reference in its entirety herein.

### FIELD OF THE INVENTION

The present invention generally relates to high concentration Plant Growth Regulators (PGRs) in non-aqueous, low volatility solutions, methods for making non-aqueous, low volatility solutions, and methods for improving the growth and crop productivity of plants using said non-aqueous solutions.

### DESCRIPTION OF THE PRIOR ART AND OBJECTIVES OF THE INVENTION

As provided in International Publication No. WO 2012/068473, the contents of which are expressly incorporated herein by reference in their entirety, plant growth and development as well as productivity (e.g., crops, seeds, fruits etc.) are known to be regulated by growth factors, mineral components, and small molecules that signal for the expression of genes that enhance the level of plant productivity, whether in quantity or quality. Traditional approaches for improving plant productivity have included the application of various minerals and nitrogen components as necessary additions or substrates to crop plant or other plant productivity. However, such approaches have tended to knowingly, or unknowingly, disregard the growth factors (e.g., phytohormones and/or other small molecules) required for enhanced productivity.

Traditionally, mineral fertilizers have been predominately applied to growing crop plants. Difficulties arise, however, when external stresses impede successful plant development, especially of grain or seed crops and/or other crops. Physical stresses, such as those inflicted by environmental temperatures being either too low or too high, and in particular high temperatures, are especially problematic. Moreover, the state-of-the-art agronomic practice does not employ plant growth regulators to overcome a plant's difficulty, due to such stresses, in producing sufficient amounts of nutrients, e.g., sugars, to prevent autophagy (i.e., cannibalization of previously formed plant cells by newly formed cells to compensate for a dearth of cell nutrients). It is well known that mineral fertilizers provide up to eighteen minerals that are necessary for crop growth and development. Signaling molecules, such as plant growth regulators or other molecules, are known to enhance crop productivity through the expression of certain genes. Furthermore, much research has been conducted into the use of plant growth regulators and their effects on plant growth and development.

An alternative, more natural approach, which is becoming ever more appreciated, is based upon the theory that plants already have the necessary genes/genetic code to produce greater quantities and/or qualities of various plant tissues as well as to thrive in the face of common adversities, such as drought, disease, and insect infestations. But, to realize the full expression of this innate genetic material and the plant's full potential, the plant must receive various naturally occurring nutrients and/or phytohormones in specific concentrations, at specific times during the plant's growth, and to specific parts or tissues of the plant.

As provided in International Publication No. WO 2005/021715, the contents of which are expressly incorporated herein by reference in their entirety, plant hormones have been studied for years. Plant hormones may be assigned to one of a few categories: auxins, cytokinins, gibberellins, abscisic acid, brassinosteroids, jasmonates, salicylic acids, polyamines, peptides, nitric oxides, strigolactones and/or ethylene. Ethylene has long been associated with fruit ripening and leaf abscission. Abscisic acid causes the formation of winter buds, triggers seed dormancy, controls the opening and closing of stomata and induces leaf senescence. Gibberellins, primarily gibberellic acid, are involved in breaking dormancy in seeds and in the stimulation of cell elongation in stems. Gibberellins are also known to cause dwarf plants to elongate to normal size. Cytokinins are produced primarily in the roots of plants. Cytokinins stimulate growth of lateral buds lower on the stem, promote cell division and leaf expansion and retard plant aging. Cytokinins also enhance auxin levels by creating new growth from meristematic tissues in which auxins are synthesized. Auxins promote both cell division and cell elongation and maintain apical dominance. Auxins also stimulate secondary growth in the vascular cambium, induce the formation of adventitious roots and promote fruit growth.

The most common naturally occurring auxin is indole-3-acetic acid (IAA). However, synthetic auxins, including indole-3-butyric acid (IBA); naphthalene acetic acid (NAA); 2,4-dichlorophenoxy acetic acid (2,4-D); and 2,4,5-trichlorophenoxy acetic acid (2,4,5-T or Agent Orange) are known. While these are recognized as synthetic auxins, it should be acknowledged that IBA does naturally occur in plant tissues. Many of these synthetic auxins have been employed for decades as herbicides, producing accelerated and exaggerated plant growth followed by plant death. Agent Orange gained widespread recognition when it was used extensively by the United States Army and Air Force in defoliation applications during the Vietnam War. 2, 4-D finds continuing use in a number of commercial herbicides sold for use in agriculture, right of way, and turf and ornamental markets.

Agriculturally, active ingredients are often provided in the form of concentrates suitable for dilution with water. Many forms of agricultural concentrates are known, and these consist of the active ingredient and a carrier, which can include various components. Water-based concentrates are obtained by dissolving, emulsifying and/or suspending agriculturally active technical materials in water. Due to the relatively complex supply chain for crop protection agents, such concentrate formulations can be stored for long periods and may be subjected to extreme temperature variations, high-shear and repetitive vibration patterns (by way of example, during storage or shipping). Such supply chain conditions can increase the likelihood of formulation failure due to, for example, water mediated degradation and stability problems.

Accordingly, the efficient use of aqueous systems with certain agrochemicals and crop protection agents is restricted due to their poor chemical stability when exposed to water during storage. Typically, hydrolysis is the most common water-mediated degradation mechanism; however, agricultural concentrates with water-sensitive active ingredients are also subject to oxidation, dehalogenation, bond cleavage, Beckmann rearrangement and other forms of degradation on exposure to water.

In some cases, it may be desirable to combine different agrochemicals to provide a single formulation taking advantage of the additive properties of each separate agrochemical and optionally an adjuvant or combination of adjuvants that provide optimum biological performance. For example, transportation and storage costs can be minimized by using a formulation in which the concentration of the active agrochemical(s) is as high as is practicable and in which any desired adjuvants are “built-in” to the formulation as opposed to being separately mixed inside the spray tank. The higher the concentration of the active agrochemical(s) however, the greater the probability that the stability of the formulation may be disturbed, or that one or more components may phase separate.

Another challenge arises where a user of an agrochemical liquid concentrate formulation dilutes the formulation in water (for example in a spray tank) to form a dilute aqueous spray composition. Such agrochemical spray compositions are widely used, but their performance may be limited by the tendency for certain agrochemicals to degrade in a spray tank on exposure to water. For example, agrochemical breakdown can increase with increasing alkalinity and water temperature, and with the length of time the spray composition is left in the tank.

Considering the variety of conditions and special situations under which agrochemical liquid concentrate formulation are stored, shipped and used around the world, there remains a need for concentrate formulations of agrochemicals, including water sensitive agrochemicals that provide stability benefits under at least some of those conditions and situations. There is a further need for such formulations having high loading that are stable before being diluted with water under a wide range of field conditions.

U.S. Patent Publication 2012/0045497, the contents of which are expressly incorporated herein by reference in their entirety, documents the stabilizing of liquid agrochemical compositions which comprise flowable, non-aqueous dispersion concentrates comprising a continuous substantially water-miscible liquid phase, a dispersed water-immiscible liquid phase, and a colloidal solid.

Furthermore, it is known that gibberellins and abscisic acid cannot be directly applied to a crop and require a solvent system as a carrier for such applications. Since gibberellins are slowly hydrolyzed in aqueous solutions, they cannot be stored long-term in aqueous solutions. Commercial solutions are generally considered non-aqueous. Gibberellins are known to be dissolved in methanol. Methanol is both flammable and poisonous at commercially relevant volumes and concentrations, and as such, the Dangerous Goods Regulations (DGR) requires that all products which contain methanol, including gibberellin solutions, be marked as both flammable and poisonous and handled accordingly which has led to increased restrictions in some states and countries. Accordingly, U.S. Patent Publication 2003/0013610, the contents of which are expressly incorporated herein by reference in their entirety, proposes the use of a lipophilic solvent system. It has been found that the lack of solubility of gibberellins in lipophilic solvents has been overcome through the use of certain lipophilic solvent systems. This is of interest because they are not flammable like methanol. Such systems include a plant growth promoter composition comprising: (a) not in excess of 20% by weight of one or more gibberellins; and (b) an essentially non-aqueous solvent system comprising: (i) 30 to 99% by weight of one or more lipophilic solvents; (ii) at least an equivalent molar amount to the gibberellin(s) of one or more lipophilic alkaline coupling agents which enable the gibberellin(s) to form a lipophilic solvent soluble complex; (iii) 1 to 50% by weight of one or more emulsifiers which blend with the lipophilic solvent(s) to form a homogeneous product and enable dispersion of the composition into water for application; and (iv) optionally, not in excess of 15% by weight of one or more viscosity reducing co-solvents.

As demonstrated in U.S. Pat. No. 10,104,883, the contents of which are expressly incorporated herein by reference in their entirety, the use of aprotic solvents such as propylene glycol stabilizes the PGRs of cytokinins, auxins and gibberellins but is limited to concentration of these combinations below 0.30% of the gibberellin, 0.30% of the cytokinin, and 1% of the auxin in the mixture. Furthermore, propylene glycol has a comparatively low boiling point in relation to other commercially relevant solvents. As demonstrated in US 20230247985A1, the use of aprotic solvents such as polyethylene glycol 200 stabilizes the PGRs of cytokinins, auxins and gibberellins but is limited to concentration of these combinations below 0.10% of the gibberellin, 0.10% of the cytokinin, and 0.05% of the auxin in the mixture. With both the lower concentrations and higher volatility, the logistical cost of transport and bottling becomes impactful for providing a cost-effective solution to the market. Therefore, there is still an unmet need in the art for a stable mixture of these PGR in a formulation for commercial use that provides a higher concentration and has low volatility (VOC).

### SUMMARY OF THE INVENTION

The present disclosure is directed to a low volatility, non-aqueous solution of 1) a mixture of plant growth regulators and 2) at least one polar organic solvent with a low VOC. The present disclosure further includes methods for making said non-aqueous solution, and methods for improving the growth and crop productivity of plants using said non-aqueous solution. Low VOC stable liquid formulations are generally achieved by using a low VOC solvent system. On May 30, 2006, the California Department of Pesticide Regulation (DPR) announced an air quality initiative to reduce pesticide-related emissions of volatile organic compounds (VOC). All pesticide formulations sold in California require <30% VOC content as estimated by thermogravimetry analysis (TGA). Therefore, a low VOC solvent system designated above would meet the DPR requirements. Generally, the nonaqueous liquid solution of the present disclosure has a low level of volatile organic chemicals such that the vapor pressure of the nonaqueous liquid solution is less than 0.08 mm Hg at 20° C. or the nonaqueous liquid solution has a volatile organic chemical (VOC) emission potential of 25%. The present disclosure includes methods by which plant growth can be manipulated through the addition of said non-aqueous solution by application to roots or aerial tissues.

The present disclosure is directed to methods for improving the growth and crop productivity of plants by introducing plant growth regulators, such as phytohormones, to the tissue of the plant using polar and semi-polar organic solvent(s). In the methods of the present disclosure, a plant hormone in an amount effective to produce the desired effect, e.g., improved growth, improved fruit set, or improved plant architecture, is dissolved in polar and semi-polar organic solvent(s) and applied as an aqueous solution to the plant tissue.

The low volatility non-aqueous solution containing plant growth regulators has a potential for higher concentration and lower volatility than what is in prior art. This higher concentration and lower volatility provides a more cost-effective solution to the marketplace. This solution improves plant architecture by producing a stockier, more compact plant characterized by increased branching, shorter stem internodes, prolific root development and thicker leaves with enhanced photosynthetic capacity and sugar production. This architectural change increases photosynthate storage capacity, flowering points, fruit initiation, sizing and retention, and ultimately yield.

### DETAILED DESCRIPTION OF THE PREFERRED EMBODIMENT AND OPERATION OF THE INVENTION

The non-aqueous solution of the present disclosure includes: 1) a mixture of plant growth regulators and 2) at least one polar organic solvent with a low VOC. Herein are also disclosed methods for making said non-aqueous low volatility solution and methods for improving the growth and crop productivity of plants using said non-aqueous solution. The present disclosure includes methods by which plant growth can be manipulated through the addition of said high non-aqueous, low volatility solution by application to plant tissue.

As provided herein, it is understood that the term “non-aqueous” may include small amounts of water, preferably less than 5 wt. %, preferably less than 4 wt. %, preferably less than 3 wt. %, preferably less than 2 wt. %, preferably less than 1 wt. %, and preferably less than 0.5 wt. %. However, it is preferred that water is not intentionally added to the present non-aqueous solution.

### Plant Growth Regulators/Phytohormones

While the plant growth regulators (PGRs) provided in the non-aqueous solution may be any effective plant hormones, the phytohormone is preferably selected from ethylene, auxins, cytokinins, gibberellins, abscisic acid, brassinosteroids, jasmonates, salicylic acids, peptides, polyamines, nitric oxide, strigolactones, precursors, derivatives and mixtures thereof.

The auxin is preferably selected from the group consisting of the natural auxins, synthetic auxins, auxin metabolites, auxin precursors, auxin derivatives and mixtures thereof. The preferred auxin is a natural auxin, most preferably indole-3-acetic acid. The presently preferred synthetic auxin is indole-3-butyric acid (IBA). Other exemplary synthetic auxins which may be employed in the present invention include indole 3-propionic acid, indole-3-butyric acid, phenylacetic acid, naphthalene acetic acid (NAA), 2,4-dichlorophenoxy acetic acid, 4-chloroindole-3-acetic acid, 2,4,5-trichlorophenoxy acetic acid, 2-methyl-4-chlorophenoxy acetic acid, 2,3,6-trichlorobenzoic acid, 2,4,6-trichlorobenzoic acid, 4-amino-3,4,5-trichloropicolinic acid and mixtures thereof.

The cytokinin is preferably selected from one or more of the following: zeatin, various forms of zeatin, N6-benzyl adenine, N6-(delta-2-isopentyl) adenine, 1,3-diphenyl urea, thidiazuron, CPPU (forchlorfenuron), kinetin or other chemical formulations with cytokinin activity. The preferred cytokinin is kinetin.

The gibberellin is preferably selected from one or more of the following: GAi, GA2, GA₃, GA₄, GA₅, GA₆, GA7, GA₈, GA9, GA10, GA11, GA,2, GA,₃, GA,₄, GA,₅, GA₁₆, GA₁₇, GA,₈, GA₁₉, GA₂₀, GA₂i, GA₂₂, GA₂₃, GA₂₄, GA₂₅, GA₂₆, GA₂₇, GA₂₈, GA₂₉, GA₃₀, GA₃₁, GA₃₂, GA₃₃, GA₃₄, GA₃₅, GA₃₆, GA₃₇, GA₃₈, GA₃₉, GA₄₀, GA₄₁, GA₄₂, GA₄₃, GA₄₄, GA₄₅, GA₄₅, GA₄₇, GA48, GA₄₉, GAso, GA₅₁, GA₅₂, GA₅₃, GA₅₄, GA₅₅, GA₅₆, GA₅₇, GA₅₈, GA₅₉, GA₆₀, GA₆₁, GA₆₂, GA₆₃, GA₆₄, GA₆5, GA₆6, GA₆₇, GA₆₈, GA₆₉, GA₇₀, GA71, GA₇₂, GA₇₃, GA₇₄, GA₇₅, GA₇₆, GA₇₇, GA₇₈, GA₇₉, GA₈₀, GA₈i, GA₈₂, GA₈₃, GA₈, GA₈₅, GA₈₆, GA₈₇, GA₈₈, GA₈₉, GA₉o, GA₉i, GA₉₂, GA₉₃, GA₉₄, GA₉₅, GA₉₆, GA₉₇, GA₉₈, GA^, GA100, GA101, GA₎₀₂, GAio₃, GA104, GA105, GA106, GAio₇, GAios, GAi₀₉, GAno, GAm, GAn₂, GA113, GA|i₄, GA115, GA116, GAi i7, GAi is, GAn₉, GAno, GAi₂i, GAi₂₂, GAi₂₃, GAi₂₄, GAi₂₅, and/or GAi26. The preferred gibberellin is the gibberellic acid, GA₃.

The auxins, preferably indole-3-butyric acid (IBA), are present in the non-aqueous low volatile PGR mix in an amount such that the auxin is between about 0.31 to 2 wt. % and more preferably between 0.31 to 1%.

The gibberellin, and more preferably gibberellic acid (GA₃), are present in the non-aqueous low volatile PGR mix in an amount such that the auxin is between about 0.31 to 2 wt. % and more preferably between 0.31 to 1%.

The cytokinin, and more preferably kinetin, are present in the non-aqueous low volatile PGR mix in an amount such that the auxin is between about 0.31 to 2 wt. % and more preferably between 0.31 to 1%.

As provided in International Publication WO 2012/068473, the contents of which are expressly incorporated herein by reference in their entirety, in a preferred embodiment of the present disclosure, the plant growth regulator are preferably included as a PGR mixture of two plant hormones—cytokinin and gibberellin. When used together, the ratio of the plant growth regulators, cytokinin and gibberellin, preferably ranges from 1:10 to 1:300 and more preferably from 1:20 to 1:40. A ratio of approximately 1:30 is most preferable. Nonetheless, to obtain the best results, the absolute amount of the cytokinins and gibberellins vary proportionally to the volume/weight of the treated plants and their fruit.

Additionally, in a preferred embodiment of the present disclosure, the plant growth regulator may include a PGR mixture of the following two phytohormones: cytokinin and auxin. When used together, the ratio of the plant growth regulators, cytokinin and auxin, preferably ranges from 1:10 to 1:300 and more preferably from 1:20 to 1:40. A ratio of approximately 1:30 is most preferable. Nonetheless, to obtain the best results, the absolute amount of the cytokinins and gibberellins vary proportionally to the volume/weight of the treated plants and their fruit.

### Polar and Semi-polar Organic Solvent(s)

A wide variety of low volatility organic solvents may be present in the instant disclosure. A preferred embodiment of the present disclosure would include non-volatile organic solvents consisting of polyethylene glycol 200-400, and/or at least one lactamide, preferably, n,n-dimethyl lactamide and/or at least one pentanoate, preferably, methyl-5-dimethylamino-2-methyl-5-oxopentanoate, or a mixture thereof.

### Additional Ingredients Includes/Excluded

A preferred embodiment of the present disclosure includes the addition of surfactants, antifoams, and/or preservatives known to those of skill in the art. The surfactant may include, but are not limited to, the group consisting of carboxylates, sulfonates, natural oils, alkylamides, arylamides, alkylphenols, arylphenols, ethoxylated alcohols, polyethylene, carboxylic esters, polyalkylglycol esters, anhydrosorbitols, glycol esters, carboxylic amides, monoalkanolamine, polethylene fatty acid amides, polysorbates, cyclodextrins, sugar based, silicone based, polyalkylated alcohols, and alkylaryl ethoxylates. In a preferred embodiment, the non-aqueous solution consists of substantially all of the plant growth regulator(s), optional mineral(s), surfactant, and the polar and semi-polar organic solvent(s) and any impurities inherent therein.

In an alternate preferred embodiment, the non-aqueous solution includes one solvent, that is, the polar and semi-polar organic solvent. As previously indicated this non-aqueous solution may include small amounts of water, preferably less than 5 wt. %, more preferably less than 1 wt. %, and most preferably less than 0.5 wt. %. Most preferably, the low VOC solution only includes one solvent, that is, the low VOC solvent with no intentional addition of water.

### Method of Making

The non-aqueous solution is generally produced by dissolving at least two plant growth regulators in at least one low VOC organic solvent at a temperature up to the boiling point of the polar and semi-polar organic solvent, more preferably below 120° C. and most preferably below 100° C.

### Application to Plants

In a preferred embodiment, the non-aqueous solution is combined with water prior to application to the plant (e.g. within a few hours of application to the plant) to provide a water-diluted composition. The amount of water added to the non-aqueous solution depends on the required concentration of the active ingredients needed to regulate plant growth as known to those of skill in the art.

In a more preferred embodiment of the methods of the present disclosure, a water-diluted composition of the non-aqueous solution of the plant growth regulator is applied to the roots, foliage, flowers or fruits of a plant after planting. While application to the roots or tubers prior to planting or by soil application after planting, may produce the best results in some circumstances, in others, application to the foliage may be preferred. The specific crop and the desired result must be taken into account when selecting an application method. The non-aqueous solution and/or water-diluted composition including the non-aqueous solution may be applied using conventional irrigation or spray equipment.

The method preferably includes the application of the non-aqueous solution of plant growth regulators, such as a cytokinin, to the foliage and/or flowers of plants at or about the time of the beginning of plant flowering (e.g., during meiosis and when pollen is about to enter dehiscence). The non-aqueous solution may be applied to the soil in any appropriate fashion, such as, for example, in an opened furrow near the plant roots, which furrow may subsequently be closed. It may also be applied with various forms of irrigation, such as overhead or drip tape, or furrow irrigation, among others. Application of agricultural chemicals may be accomplished in any of several ways well known to those skilled in the art, including but not limited to, foliar applications, soil applications, irrigation applications, etc. In a preferred method of the invention, the non-aqueous solution is readied and applied to the roots of growing plants, or via the soil in which the plants are growing, through drip irrigation. Other fertigation-type application methods that may be employed include, but are not limited to, broadcasting (e.g. conventional irrigation) and other types of placement application (e.g. side dressing; microjets, etc.). Broadcast application is an acceptable method, if sufficient irrigation is permitted to wash the non-aqueous solution from the foliage and above-ground tissues of the plants and into the soil/roots.

The present disclosure includes seeds, seed pieces, dry fertilizer, talc, gypsum or tubers for producing plants having dispersed on the surface thereof a phytohormone, e.g., an auxin or other PGR, in an amount effective to alter plant architecture as explained above, but in an amount insufficient to negatively affect growth of the plant tissues. When applied as a non-aqueous solution, the non-aqueous solution containing the plant growth regulator, e.g., an auxin or another PGR, may be sprayed on seeds or tubers using conventional spray equipment. Alternatively, the seeds, fertilizer, talc, gypsum or tubers may be immersed in a non-aqueous solution of the plant growth regulator. Seeds, fertilizers, talc, gypsum or tubers may be treated prior to planting by spraying with or by immersion in such non-aqueous solutions.

The preferred method of applying PGRs may be along with a boron-containing solution. Boron will stabilize the auxin in plant tissues to which such solutions are applied. The application of a metal or metalloid, preferably boron, together with the PGR extends the effective life of the PGR, thus permitting longer times between repeat applications. Additionally, boron has been reported to have insecticidal, fungicidal and bacteriocidal activities. Accordingly, it is believed that application of PGRs, together with boron, will improve the effect of the PGR in suppressing insect and pathogen infestation in plants.

Preferably, but optionally, a low concentration of potassium is also applied together with the plant growth regulator to enhance the effects of the plant hormone. Potassium, if applied with the cytokinin, is preferably applied at very low concentrations between about ¼ lb. to about 2 lbs. per acre, more preferably between about ½ lb. to about 1½ lbs. per acre, and most preferably about 1 lb. per acre.

While the methods of the present disclosure may be used with substantially all plants, they are particularly useful when applied to crop plants, e.g., dry beans, soy beans, onions, cucumbers, tomatoes, potatoes, corn, cotton, canola, wheat and the like. In a first step of applying the non-aqueous solution to the plants, the plant hormone is readied for application to the plants to be treated. The plant hormone is preferably applied to the plants in a non-aqueous solution. Therefore, readying the plant hormone may include one or more of the following activities: diluting the non-aqueous solution of the plant hormone with sufficient amounts of solvent to create the desired concentration of plant hormone, adding low concentrations of minerals and/or other fertilizers to the diluted solution to enhance the effects of the applied plant hormone, loading the non-aqueous solution of the plant hormone (with or without minerals and/or fertilizers) into a sprayer or tank for subsequent application to the plants to be treated, calibrating the sprayer or dosing applicator to meter the desired amount of the solution of the plant hormone to the plants to be treated and transporting the solution of the plant hormone (with or without minerals and/or fertilizers) the location of the plants to be treated.

As provided in International Publication No. WO 2005/021715, the contents of which are expressly incorporated herein by reference in their entirety, auxin level may be manipulated within a desired range by application of a plant growth regulator or phytohormone, e.g., cytokinin or gibberellic acid.

International Publication No. WO 2012/135366 and U.S. Publication No. 2012/0295788, the contents of which are expressly incorporated herein by reference in their respective entireties, teach exogenous application to the plant canopy (i.e. leaves and flowers) of the plant growth regulator/phytohormone cytokinin. Additionally, the application of low concentrations of potassium along with the cytokinin has been found to substantially increase the effect of the cytokinin.

### EXAMPLES

The following examples are intended to illustrate the present invention and to teach one of ordinary skill in the art how to make and use the invention. They are not intended to limit the invention or its protection in any way. The non-aqueous solution is generally produced by dissolving at least two plant growth regulators in at least one low VOC organic solvent at a temperature up to the boiling point of the polar and semi-polar organic solvent, more preferably below 120° C. and most preferably below 100° C.

TABLE 1
Stability of Kinetin IBA, and GA3 in
Polyethylene Glycol 200, 300 and 400

| Ingredient | A | B | C | D | E |
|---|---|---|---|---|---|
| Kinetin | 0.11% | 0.11% | 0.11% | 0.31% | 1.0% |
| Indole 3- | 0.06% | 0.06% | 0.06% | 0.31% | 1.0% |
| Butyric Acid | | | | | |
| Gibberellic | 0.11% | 0.11% | 0.11% | 0.31% | 1.0% |
| Acid (GA3) | | | | | |
| Polyethylene | 99.72% | NA | NA | 99.07% | 97.0% |
| Glycol (200) | | | | | |
| Polyethylene | NA | 99.72% | NA | NA | NA |
| Glycol (300) | | | | | |
| Polyethylene | NA | NA | 99.72% | NA | NA |
| Glycol (400) | | | | | |
| Total | 100 | 100 | 100 | 100 | 100 |

Five formulations containing kinetin, Indole-3-Butyric Acid, Giberrellic Acid were prepared by dissolving the plant growth regulators in various polyethylene glycol solvents at up to the boiling point of the polar and semi-polar organic solvent between 80 and 120° C. containing less than 5% water as set forth in Table 1 above. The EPA Guidelines on Stability that issued on Nov. 16, 2012 to the Office of Pesticide Programs (OPP) relating to “Accelerated Storage Stability and Corrosion Characteristics Study Protocol”, which are incorporated herein by reference, were followed using clear bottles to allow for UV radiation to be available to the solutions. As provided in the EPA, FAO, and WHO Guidelines, accelerated storage stability can be used to fulfill EPA and multi national regulatory data requirements. OPP has determined that this study, conducted for 14 days at an elevated temperature (54° C.), provides adequate data in certain circumstances to allow EPA to make a regulatory finding regarding the stability of the product and the effect of the formulation on the product packaging. The Manual on the Development and Use of FAO and WHO Specifications for Pesticides, the contents of which are incorporated herein by reference, cites the tolerance for active ingredient in a formulated product is +/−10% for formulations with less than 2.5% active content. After the 14 days under the Accelerated Storage Stability, all five formulations showed less than 9% loss; thereby, indicating all formulations were stable.

TABLE 2
Stability of Kinetin IBA, and GA3 in
n,n-Dimethyl Lactamide, and Methyl-5-
dimethylamino-2-methyl-5-oxopentanoate
(Rhodiasolv ® PolarClean).

| Ingredient | A | B | C | D | E |
|---|---|---|---|---|---|
| Kinetin | 0.31% | 0.31% | 0.31% | 1.0% | 1.0% |
| Indole 3- | 0.31% | 0.31% | 0.31% | 1.0% | 1.0% |
| Butyric Acid | | | | | |
| Gibberellic | 0.31% | 0.31% | 0.31% | 1.0% | 1.0% |
| Acid (GA3) | | | | | |
| N,N-Diethyl | 99.07% | NA | NA | 97.0% | NA |
| Lactamide | | | | | |
| Rhodiasolv ® | NA | 99.07% | NA | NA | 97.0% |
| PolarClean | | | | | |
| Propylene Glycol | NA | NA | 99.07% | NA | NA |
| Total | 100 | 100 | 100 | 100 | 100 |

Five formulations containing Kinetin, Indole-3-Butyric Acid, Giberrellic Acid were prepared by dissolving the plant growth regulators in N,N-Dimethyl Lactamide, Methyl-5-dimethylamino-2-methyl-5-oxopentanoate, and Propylene Glycol at up to the boiling point of the polar and semi-polar organic solvent between 80 and 120° C. containing less than 5% water as set forth in Table 1 above. After the 14 days under the Accelerated Storage Stability, formulations with N,N-Dimethyl Lactamide, and Methyl-5-dimethylamino-2-methyl-5-oxopentanoate showed less than 9% loss; but, the lower plant growth regulator concentrations formula with propylene glycol demonstrated greater than 10% loss.

Although the present invention has been disclosed in terms of a preferred embodiment, it will be understood that numerous additional modifications and variations could be made thereto without departing from the scope of the invention

### Patent Citations

GB961092A 1962-04-271964-06-17Shell Res LtdA process for increasing the useful yield of plants

U.S. Pat. No. 4,769,061A 1983-01-051988-09-6Calgene Inc.Inhibition resistant 5-enolpyruvyl-3-phosphoshikimate synthase, production and use

U.S. Pat. No. 6,071,857A 1996-06-282000-06-6Novartis Crop Protection, Inc. Pesticidal compositions

US 20030013610A1 2000-02-232003-01-16Killick Robert WilliamPlant growth hormone compositions

WO2005060755A1 2003-12-222005-07-07Botanic Agricultural Researches Ltd. Composition and method for controlling fruit production in ornamental plants

US 20050288188A1 2004-06-282005-12-29Helena Holding CompanyManufacture and use of a plant growth regulating compound

WO2006065935A2 2004-12-172006-06-22Vertec Biosolvents, Inc. Liquid formulation of a plant growth regulator

US 20080039322A1 2004-05-242008-02-14Yueh WangStable and Water-Soluble Plant Growth Regulator Liquid Compositions and Methods for Use of Same

US 20110021353A1 2009-07-242011-01-27ArborSystemsMethod for application of pesticides and plant growth regulators and nutrients to plants

U.S. Pat. No. 8,207,091B2 *2004-03-022012-06-26Stoller Enterprises, Inc. Methods for improving growth and crop productivity of plants by adjusting plant hormone levels, ratios and/or co-factors

US 20120220459A1 2007-01-312012-08-30Yueh WangStable s-(+)-abscisic acid liquid and soluble granule formulations

FR2999385A1 2012-12-142014-06-20NufarmLiquid solution, useful for treating plants and vegetables, comprises plant growth regulator e.g. gibberellin A3 and polar aprotic solvent including 1,3-dioxolan-4-yl-methanol compound, 1,3-dioxan-5-ol compound and/or dicarbonyl compound

U.S. Pat. No. 8,791,145B2 2010-05-272014-07-29Akzo Nobel Chemicals International B.V.Agricultural formulations with acyl morpholines and polar aprotic co-solvents

US 20150080216A1 2013-09-132015-03-19Fine Agrochemicals Ltd. Plant Growth Regulating Composition and Methods for Making and Using Same

US 20150173365A1 2013-12-202015-06-25Valent Biosciences CorporationLow voc gibberellin formulations

U.S. Pat. No. 9,326,452B2 2012-04-032016-05-03Stoller Enterprises, Inc. Plant growth mixture enhancing deep plant root growth and signaling for drought tolerance

US 20160286801A1 2013-03-152016-10-06Suncor Energy Inc. Herbicidal Compositions

U.S. Pat. No. 10,104,883B2 *2015-01-142018-10-23Stoller Enterprises, Inc. Non-aqueous solution of plant-growth regulator(s) and polar and/or semi-polar organic solvent(s)

### Family To Family Citations

WO2005021715A2 2003-08-222005-03-10Stoller Enterprises, Inc. Methods for improving growth and crop productivity of plants by adjusting plant hormone levels, ratios and/or co-factors

U.S. Pat. No. 8,946,122B2 2009-01-092015-02-03Syngenta Crop Protection LlcPesticidal combinations

JP2014503498A 2010-11-19201402-13 [symbol] [symbol] [symbol] . Plant growth enhancing mixture and method of applying the mixture

US 20120252673A1 2011-03-292012-10-04Stoller Enterprises, Inc. Composition and method for stress mitigation in plants

U.S. Pat. No. 10,104,883B2 2016-01-142018-10-23Stoller Enterprises, Inc. Non-aqueous solution of plant-growth regulator(s) and polar and/or semi-polar organic solvent(s)

US 20230247985A1 Stoller Enterprises, Inc. Non-aqueous solution of plant-growth regulator(s) and polar and/or semi-polar organic solvent(s)

I Claim:

1. A non-aqueous solution comprising:
a) a plant growth regulator mixture including 0.31 to 1 wt. % of at least one cytokinin, 0.31 to 1 wt. % of at least one gibberellin, and 0.31 to 1 wt. % of at least one auxin;
b) at least one organic solvent defining low volatility selected from n,n-dimethyl lactamide, and/or methyl-5-dimethylamino-2-methyl-5-oxopentanoate and optionally combinations thereof;
c) optionally at least one mineral, optionally at least one surfactant, optionally at least one antifoam, optionally at least one preservative, and optionally combinations thereof, and
d) less than 5 wt. % water;
wherein said non-aqueous solution is stable and said at least one organic solvent and said less than 5 wt. % water are the only solvents present in said non-aqueous solution.

2. A non-aqueous solution comprising:
a) a plant growth regulator mixture including 0.001 to 1 wt. % of at least one cytokinin, 0.001 to 1 wt. % of at least one gibberellin, and 0.31 to 1 wt. % of at least one auxin;
b) at least one organic solvent defining low volatility selected from n,n-dimethyl lactamide and/or methyl-5-dimethylamino-2-methyl-5-oxopentanoate and optionally combinations thereof;
c) optionally at least one mineral, optionally at least one surfactant, optionally at least one antifoam, optionally at least one preservative, and optionally combinations thereof; and
d) less than 5 wt. % water;
wherein said non-aqueous solution is stable and said at least one organic solvent and said less than 5 wt. % water are the only solvents present in said non-aqueous solution.

3. A non-aqueous solution comprising:
a) a plant growth regulator mixture including 0.001 to 1 wt. % of at least one cytokinin, 0.31 to 1 wt. % of at least one gibberellin, and 0.001 to 1 wt. % of at least one auxin;
b) at least one organic solvent defining low volatility selected from n,n-dimethyl lactamide and/or methyl-5-dimethylamino-2-methyl-5-oxopentanoate and optionally combinations thereof;
c) optionally at least one mineral, optionally at least one surfactant, optionally at least one antifoam, optionally at least one preservative, and optionally combinations thereof; and
d) less than 5 wt. % water;
wherein said non-aqueous solution is stable and said at least one organic solvent and said less than 5 wt. % water are the only solvents present in said non-aqueous solution.

4. A non-aqueous solution comprising:
a) a plant growth regulator mixture including 0.31 to 1 wt. % of at least one cytokinin, 0.001 to 1 wt. % of at least one gibberellin, and 0.001 to 1 wt. % of at least one auxin;
b) at least one organic solvent defining low volatility selected from n,n-dimethyl lactamide and/or methyl-5-dimethylamino-2-methyl-5-oxopentanoate, and optionally combinations thereof;
c) optionally at least one mineral, optionally at least one surfactant, optionally at least one antifoam, optionally at least one preservative, and optionally combinations thereof; and
d) less than 5 wt. % water;
wherein said non-aqueous solution is stable and said at least one organic solvent and said less than 5 wt. % water are the only solvents present in said non-aqueous solution.

5. A non-aqueous solution comprising:
a) a plant growth regulator mixture including 0.11 to 1 wt. % of at least one cytokinin, 0.11 to 1 wt. % of at least one gibberellin, and 0.06 to 1 wt. % of at least one auxin;
b) at least one organic solvent defining low volatility selected from polyethylene glycol 200, polyethylene glycol 300, and/or polyethylene glycol 400 and optionally combinations thereof;
c) optionally at least one mineral, optionally at least one surfactant, optionally at least one antifoam, optionally at least one preservative, and optionally combinations thereof; and
d) less than 5 wt. % water;
wherein said non-aqueous solution is stable and said at least one organic solvent and said less than 5 wt. % water are the only solvents present in said non-aqueous solution.

6. A non-aqueous solution comprising:
a) a plant growth regulator mixture including 0.001 to 1 wt. % of at least one cytokinin, 0.001 to 1 wt. % of at least one gibberellin, and 0.06 to 1 wt. % of at least one auxin;
b) at least one organic solvent defining low volatility selected from polyethylene glycol 200, polyethylene glycol 300, and/or polyethylene glycol 400 and optionally combinations thereof;
c) optionally at least one mineral, optionally at least one surfactant, optionally at least one antifoam, optionally at least one preservative, and optionally combinations thereof; and
d) less than 5 wt. % water;
wherein said non-aqueous solution is stable and said at least one organic solvent and said less than 5 wt. % water are the only solvents present in said non-aqueous solution.

7. A non-aqueous solution comprising:
a) a plant growth regulator mixture including 0.001 to 1 wt. % of at least one cytokinin, 0.11 to 1 wt. % of at least one gibberellin, and 0.01 to 1 wt. % of at least one auxin;
b) at least one organic solvent defining low volatility selected from polyethylene glycol 200, polyethylene glycol 300, and/or polyethylene glycol 400 and optionally combinations thereof;
c) optionally at least one mineral, optionally at least one surfactant, optionally at least one antifoam, optionally at least one preservative, and optionally combinations thereof; and
d) less than 5 wt. % water;
wherein said non-aqueous solution is stable and said at least one organic solvent and said less than 5 wt. % water are the only solvents present in said non-aqueous solution.

8. A non-aqueous solution comprising:
a) a plant growth regulator mixture including 0.11 to 1 wt. % of at least one cytokinin, 0.001 to 1 wt. % of at least one gibberellin, and 0.001 to 1 wt. % of at least one auxin;
b) at least one organic solvent defining low volatility selected from polyethylene glycol 200, polyethylene glycol 300, and/or polyethylene glycol 400 and optionally combinations thereof;
c) optionally at least one mineral, optionally at least one surfactant, optionally at least one antifoam, optionally at least one preservative, and optionally combinations thereof; and
d) less than 5 wt. % water;
wherein said non-aqueous solution is stable and said at least one organic solvent and said less than 5 wt. % water are the only solvents present in said non-aqueous solution.
